(19) United States
(12) Patent Application Publication
(10) Pub. No.: US 2009/0106791 A1
(43) Pub. Date: Apr. 23, 2009

(54) METHOD AND APPARATUS FOR TRANSMITTING ADDITIONAL DATA RELATED TO BROADCASTING SERVICE, AND METHOD AND APPARATUS FOR RECEIVING ADDITIONAL DATA RELATED TO BROADCASTING SERVICE

(75) Inventors: Sun-il CHOI, Suwon-si (KR); Jung-shin PARK, Suwon-si (KR); Jin-yong AHN, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO. LTD., Suwon-si (KR)

(21) Appl. No.: 12/133,946

(22) Filed: Jun. 5, 2008

(30) Foreign Application Priority Data
Oct. 19, 2007 (KR) 10-2007-0105779

(51) Int. Cl. H04N 7/10; H04N 5/14

(52) U.S. Cl. 725/32; 348/571; 348/E05.062

(57) ABSTRACT

Provided are a method and apparatus for transmitting section data and a method and apparatus for receiving section data. The method of receiving updated additional data from among additional data related to a broadcasting service includes: receiving an update information list including information regarding updates of the additional data; and receiving at least one of updated additional data based on the received update information list.

### CROSS-REFERENCE TO RELATED PATENT APPLICATION

This application claims priority from Korean Patent Application No. 10-2007-0105779, filed on Oct. 19, 2007 in the Korean Intellectual Property Office, the disclosure of which is incorporated herein in its entirety by reference.

### BACKGROUND OF THE INVENTION

1. Field of the Invention

Methods and apparatuses consistent with the present invention relate to transmitting additional data related to a broadcasting service and receiving additional data related to a broadcasting service, and more particularly, to transmitting section data and receiving section data.

2. Description of the Related Art

With the recent development of broadcasting technology, the transition from analog to digital broadcasting is gaining momentum. Since digital broadcasting utilizes digital data to carry an audio or video signal, digital broadcasting provides better picture quality and sound than analog broadcasting. Also, digital broadcasting is useful for additionally transmitting additional data related to a broadcasting service.

Digital Video Broadcasting (DVB), in which additional data related to a broadcasting service are transmitted will now be exemplarily explained. A Moving Picture Experts Group (MPEG) system is used in DVB. According to an MPEG system layer, program specific information (PSI) is defined by a user so that a system decoder can decode data in transport streams (TS).

In particular, in MPEG-2, the PSI contains four tables. The tables have sections, and one or more sections constitute one table. Information may be transmitted while being put in one section or in a plurality of sections. Additional data transported in sections may be important information related to programs which are being broadcast.

A transmitter transmits a variety of additional data. Accordingly, a receiver uses a section filter to receive desired additional data from among the variety of additional data. The section filter filters out and processes only desired section data having predetermined values in specific locations.

The section filter consumes a lot of hardware resources. In particular, since a section filter used to monitor whether section data is updated continuously consumes hardware resources, the section filter is very inefficient. In particular, since it is impossible to predict when a broadcasting receiver will be turned on, the transmitter must periodically transmit the same section data. Accordingly, although most of the section data is not updated, the section filter must be set continuously.

FIG. 1 is a flowchart illustrating a related art method of filtering section data.

In operation S110, a filter for filtering desired section data is set.

In operation S120, the desired section data is received.

In operation S130, it is determined whether the desired section data received in operation S120 is updated. If it is determined in operation S130 that the received desired section data is updated, the method proceeds to operation S140. In operation S140, a module is notified that the desired section data is updated and the module processes the updated section data. However, if it is determined in operation S130 that the received desired section data is not updated, the method returns to operation S120. In this way, operations S120 and S130 are repeated until the desired section data is updated.

In operation S150, the filtering operation ends when it is no longer necessary to monitor whether the desired section data is updated. However, if it is necessary to continuously monitor whether the desired section data is updated, operation S120 is performed again.

FIG. 2 is a view for explaining the operation of a related art section filter.

Application programs 231, 232, 233, and 234 executed by a broadcasting receiver request a section data processing module 210 to monitor whether desired section data is updated. The section data processing module 210 sets section filters 220 which monitor whether the desired section data is updated.

A first section filter 221 receives section data requested by the application program 231 and monitors whether the section data is updated. Likewise, a fourth section filter 224 receives section data requested by the application program 234 and monitors whether the section data is updated. If the section data requested by the application 234 is updated, the section filter 224 notifies the section data processing module 210 that the corresponding section data is updated.

Since the section filters used to monitor whether the section data is updated should be continuously set until the section data is updated, the section filters of the conventional method are inefficient.

To solve this problem, a time-division approach has been developed in monitoring of whether section data is updated. That is, section data ‘A’ is first monitored for a period of time T, and then section data ‘B’ is monitored for a period of time T. However, the related art time-division approach has a problem in that there is a delay between a point in time when section data is actually updated and a point in time when a receiver senses this. Accordingly, the receiver cannot recognize an order in which the section data is updated. In addition, the conventional time-division approach has another problem in that since a central processing unit (CPU) is continuously used, the receiver which has limited resources cannot use the CPU.

### SUMMARY OF THE INVENTION

The present invention provides a method and apparatus for transmitting additional data and a method and apparatus for receiving additional data, which can efficiently transmit and receive updated additional data and can guarantee an order in which the additional data is updated.

According to an aspect of the present invention, there is provided a method of receiving updated additional data among additional data related to broadcasting service, the method comprising: receiving an update information list including information regarding updates of the additional data; and receiving at least one of updated additional data on the basis of the received update information list.

The additional data and the update information list may be section data transported in MPEG-2 streams.

The receiving of the at least one of the updated additional data may comprise: receiving a monitor request signal requesting to monitor whether predetermined additional data are updated; determining whether the additional data corresponding to the monitor request signal are updated on the basis of the update information list; and receiving the additional data corresponding to the monitor request signal on the basis of the determination result.

The receiving of the additional data may comprise: if it is determined that a plurality of additional data corresponding to the monitor request signal are updated, sequentially receiving the plurality of additional data in an order in which the plurality of additional data are updated on the basis of the update information list.

The receiving of the at least one may comprise: determining whether the received update information list is updated; and receiving at least one of updated additional data on the basis of the update information list if it is determined that the update information list is updated.

The update information list may include at least one of identifiers for identifying the additional data, version information of the additional data, update time information of the additional data, and data types of the additional data.

According to another aspect of the present invention, there is provided a method of transmitting additional data related to broadcasting service, the method comprising: generating an update information list including information regarding updates of the additional data; and transmitting the generated update information list along with the additional data.

According to another aspect of the present invention, there is provided an apparatus for receiving updated additional data among additional data related to broadcasting service, the apparatus comprising: an update information list receiving unit receiving an update information list including information regarding updates of the additional data; and a receiving unit receiving at least one of updated additional data on the basis of the received update information list.

According to another aspect of the present invention, there is provided an apparatus of transmitting additional data related to broadcasting service, the apparatus comprising: an update information list generating unit generating an update information list including information regarding updates of the additional data; and a transmitting unit transmitting the generated update information list along with the additional data.

### BRIEF DESCRIPTION OF THE DRAWINGS

The above and other aspects of the present invention will become more apparent by describing in detail exemplary embodiments thereof with reference to the attached drawings in which:

FIG. 1 is a flowchart illustrating a related art method of filtering section data;

FIG. 2 is a view for explaining the operation of a related art section filter;

FIG. 3 is a block diagram of an apparatus for transmitting additional data according to an exemplary embodiment of the present invention;

FIG. 4 is a block diagram of an apparatus for receiving additional data according to an exemplary embodiment of the present invention;

FIG. 5 is a view for explaining the operation of the apparatus of FIG. 4 according to an exemplary embodiment of the present invention;

FIG. 6 is a flowchart illustrating a method of transmitting additional data according to an exemplary embodiment of the present invention;

FIG. 7 is a flowchart illustrating a method of receiving additional data according to an exemplary embodiment of the present invention; and

FIG. 8 is a flowchart illustrating a method of receiving additional data according to another exemplary embodiment of the present invention.

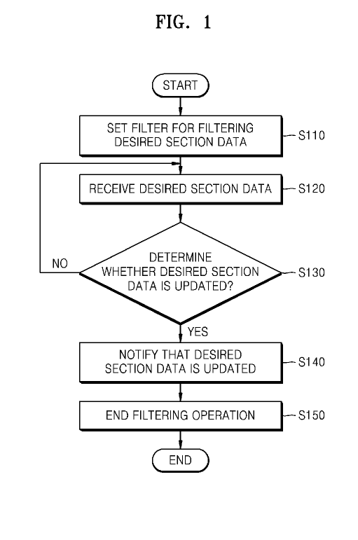

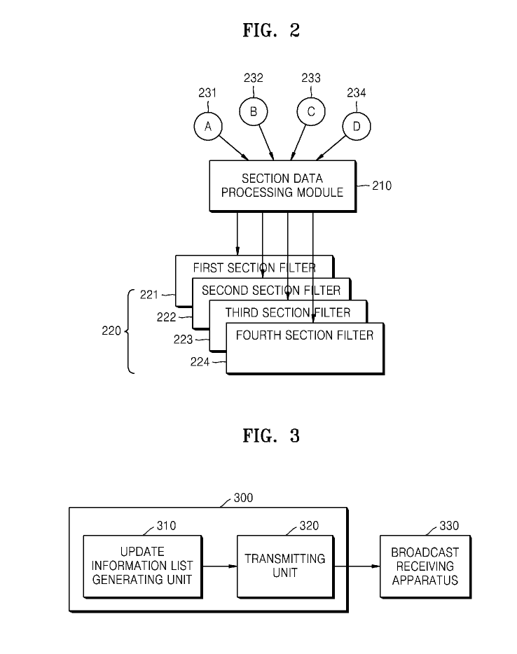

### DETAILED DESCRIPTION OF EXEMPLARY EMBODIMENTS OF THE INVENTION

The exemplary embodiments of the present invention will now be described more fully with reference to the accompanying drawings.

FIG. 3 is a block diagram of an apparatus 300 for transmitting additional data according to an exemplary embodiment of the present invention.

The apparatus 300 transmits additional data related to a broadcasting service, and includes an update information list generating unit 310 and a transmitting unit 320.

The update information list generating unit 310 generates an update information list including information regarding updates of the additional data. The additional data may be section data transported in MPEG-2 streams. The update information list may be section data having a new data structure, which includes information regarding updates of the additional data and is transmitted in the MPEG-2 streams.

The update information list may include section identifiers (IDs) for identifying the additional data. The update information list may include information regarding data types defining the syntactic properties of the additional data.

The update information list may include version information and update time information of the additional data. The update time information regarding a time when each of the additional data is updated may indicate an update time based on a system clock or indicate only a time order which refers to an order in which the additional data is updated.

If the additional data is updated, the apparatus 300 adds or changes items related to the corresponding additional data in the update information list and then transmits the same. If the update information list is section data transported in MPEG-2 streams and the additional data is updated, update information of the additional data included in the update information list is changed, and a version of the update information list is also changed. Accordingly, a broadcast receiving apparatus 330 can determine whether the additional data is updated by determining whether the version of the update information list is changed.

The transmitting unit 320 transmits the generated update information list along with the additional data to the broadcast receiving apparatus 330.

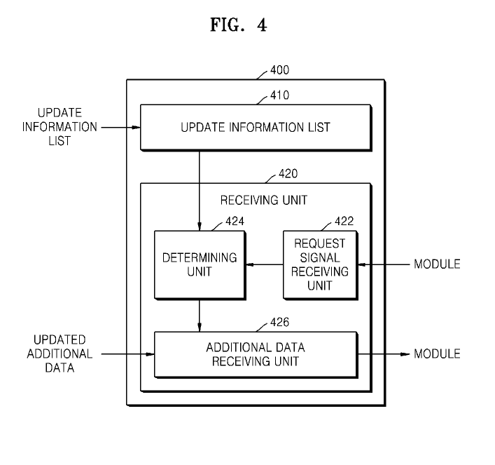

FIG. 4 is a block diagram of an apparatus 400 for receiving additional data according to an exemplary embodiment of the present invention.

The apparatus 400 receives updated additional data from among additional data related to a broadcasting service, and includes an update information list receiving unit 410 and a receiving unit 420.

The update information list receiving unit 410 receives an update information list including information regarding updates of the additional data.

The additional data and the update information list may be section data transported in MPEG-2 streams.

The update information list may include at least one of identifiers for identifying the additional data, version information of the additional data, update time information of the additional data, and data types of the additional data as described above.

The receiving unit 420 receives at least one of the updated additional data on the basis of the received update information list. The receiving unit 420 may selectively receive only desired additional data from among the updated additional data. In this case, the receiving unit 420 may include a request signal receiving unit 422, a determining unit 424, and an additional data receiving unit 426.

The request signal receiving unit 422 receives a monitor request signal requesting to monitor whether predetermined additional data is updated. The monitor request signal is a signal requesting to monitor whether additional data desired by a module related to a broadcasting service is updated. The module related to the broadcasting service may be an application system, a digital television (DTV) system, or the like. Also, the additional data desired by the module may be executable files for executing applications or subtitle files related to the broadcasting service.

The determining unit 424 determines whether the additional data corresponding to the monitor request signal is updated on the basis of the update information list.

If it is determined that the additional data corresponding to the monitor request signal is updated, the additional data receiving unit 426 receives the corresponding additional data. The additional data receiving unit 426 may not directly receive the updated additional data, and may generate a control signal in order for modules to receive the updated additional data. In this case, the additional data receiving unit 426 generates a control signal corresponding to the monitor request signal on the basis of the determination result of the determining unit 424, so that the modules transmitting the monitor request signal can directly receive the updated additional data.

If the determining unit 424 determines that a plurality of additional data corresponding to the monitor request signal is updated, the additional data receiving unit 426 sequentially receives the plurality of additional data in an order in which the plurality of additional data is updated on the basis of the update information list. Since the update information list includes information regarding a time when each piece of the additional data is updated, the additional data receiving unit 400 can guarantee an order in which the additional data is processed.

The determining unit 424 may determine whether the update information list is updated before determining whether the additional data is updated.

In this case, the additional data receiving unit 426 performs the aforementioned operations only when the determining unit 424 determines that the update information is updated. That is, if the determining unit 424 determines that the update information list is updated, the additional data receiving unit 426 receives at least one piece of the updated additional data on the basis of the updated information list. On the other hand, if the determining unit 424 determines that the update information list is not updated, the additional data receiving unit 426 determines that there is no updated additional data, and instead of parsing, skips the update information list.

In order for the determining unit 424 to easily determine whether the update information list is updated, the update information list may include version information of the update information list. In this case, if a current version of the update information list is the same as a previous version, it means that update information of the additional data is not changed, and thus the determining unit 424 determines that there is no updated additional data.

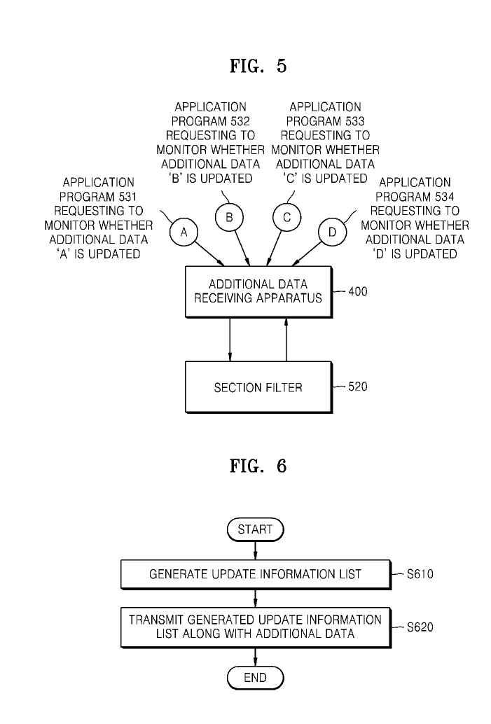

A related art apparatus determines whether a plurality of additional data is updated by using section filters corresponding in number to the plurality of additional data and receiving all the additional data, thereby resulting in inefficiency. However, the apparatus 400 of FIG. 4 uses only one section filter to selectively receive an update information list and determines whether the received update information list is changed. Next, only when the update information list is changed, does the additional data receiving unit 426 receive updated additional data by temporarily using the section filter. Compared with the related art apparatus which continuously sets the plurality of sectional filters until the additional data is updated, the apparatus 400 of FIG. 5 can efficiently use the section filter.

FIG. 5 is a view for explaining the operation of the apparatus 400 of FIG. 4 according to an exemplary embodiment of the present invention.

Additional data and an update information list in FIG. 5 are section data transported in MPEG-2 streams. However, the additional data is not limited to the section data.

It is assumed that an application program 531 requests the apparatus 400 to monitor whether additional data ‘a’ is updated, an application program 532 requests the apparatus 400 to monitor whether additional data ‘b’ is updated, an application program 533 requests the apparatus 400 to monitor whether additional data ‘c’ is updated, and an application program 534 requests the apparatus 400 to monitor whether additional data ‘d’ is updated.

The apparatus 400 sets a section filter for receiving the update information list. The section filter 520 receives only the update information list, and transmits the received update information list to the apparatus 400. The update information list may further include a header as well as information regarding updates of the additional data. The header may include an identifier for identifying the update information list, and version information of the update information list. In this case, the version information of the update information list is changed as the information regarding the updates of the additional data included in the update information list is changed. For example, if the additional data ‘d’ is changed, update information of the additional data ‘d’ included in the update information list is changed, and a version of the update information list is also changed.

The apparatus 400 may determine whether at least one piece of the additional data is updated if it is determined that the version of the received update information list is determined to be changed. Accordingly, the apparatus 400 selects at least one of updated additional data by parsing the received update information list. If it is determined that the version of the received update information list is not changed, the apparatus 400 may determine that there is no updated additional data, and thus may skip the update information list.

Table 1 shows information regarding updates of the additional data included in the update information list.

Referring to Table 1, the information included in the update information list includes identifiers for identifying the additional data, version information of the additional data, update time information of the additional data, and data types of the additional data. However, the information included in the update information list is not limited to Table 1.

TABLE 1

| Additional data | | Update | Additional |
|---|---|---|---|
| identifier | Version | order | data type |
| 1 | 2 | 2 | Subtitle information |
| 2 | 1 | 1 | Execution data |
| 3 | 2 | 3 | Channel information |
| 4 | 5 | 4 | Subtitle information |

It is assumed that the additional data ‘a’ is ‘subtitle information’ and corresponds to an identifier ‘1’, the additional data ‘b’ is ‘execution data’ and corresponds to an identifier ‘2’, the additional data ‘c’ is ‘channel information’ and corresponds to an identifier ‘3’, and the additional data ‘d’ is ‘subtitle information’ and corresponds to an identifier ‘4’.

Version information is information on a current version of each of the additional data, and an update order is an order in which the additional data is updated to the current versions. Although information on the update order is used as the update time information in FIG. 5, information on a time when each piece of the additional data is updated to the current version may be used as the update time information.

It is assumed herein below that the additional data ‘a’ and the additional data ‘d’ are updated. The update information list changes information regarding the updated additional data ‘a’ and the additional data ‘d’.

Table 2 shows information regarding updates of the additional data included in the update information list when the additional data ‘a’ and the additional data ‘d’ are updated.

TABLE 2

| Additional data | | Update | Additional |
|---|---|---|---|
| identifier | Version | order | data type |
| 1 | 3 | 4 | Subtitle information |
| 2 | 1 | 1 | Execution data |
| 3 | 2 | 2 | Channel information |
| 4 | 6 | 3 | Subtitle information |

Referring to Table 2, since the additional data ‘a’ is changed, the version information of the identifier ‘1’ corresponding to the additional data ‘a’ is changed. Accordingly, the version of the additional data ‘a’ is changed from ‘2’ to ‘3’. Since the additional data ‘d’ is changed, the version information of the identifier ‘4’ corresponding to the additional data ‘d’ is changed. Accordingly, the version of the additional data ‘d’ is changed from ‘5’ to ‘6’.

The update order of the additional data is also changed. If it is assumed that the additional data ‘d’ is updated earlier than the additional data ‘a’, the additional data is updated in the order of the additional data ‘b’, the additional data ‘c’, the additional data ‘d’, and the additional data ‘a’. Accordingly, the update order is changed according to the order of the additional data ‘b’, the additional data ‘c’, the additional data ‘d’, and the additional data ‘a’.

The apparatus 400 can confirm that the version of the update information list is changed on the basis of a header of the update information list transmitted by the section filter 520. The fact that the version of the update information list is changed means that the additional data is updated as described above. The apparatus 400 determines whether the additional data ‘a’, ‘b’, ‘c’, and ‘d’, which are requested to be monitored, are updated by parsing the update information list. Since the version information of the identifier ‘1’ and the identifier ‘4’ is changed in FIG. 5, the apparatus can easily determine that the additional data ‘a’ and the additional data ‘d’ are updated.

The apparatus 400 may receive the updated additional data ‘a’ and additional data ‘d’ and transmit the same respectively to the application program 531 and the application program 534. Alternatively, the apparatus may control the additional data ‘a’ and the additional data ‘d’ to be received by the application programs 531 and 534 by notifying the application programs 531 and 534 that the additional data ‘a’ and the additional data ‘d’ are updated.

If it is assumed that the apparatus 400 directly receives the additional data, the apparatus 400 may receive the additional data ‘a’ and the additional data ‘d’ with reference to the update order included in the update information list. That is, since the additional data ‘d’ is updated earlier than the additional data ‘a’, the apparatus 400 receives first the additional data ‘d’ using a section filter (not shown) for selectively receiving the additional data ‘d’, and then receives the additional data ‘a’ using a section filter (not shown) for selectively receiving the additional data ‘a’.

In this regard, the apparatus 400 of FIG. 5 can guarantee the update order of the additional data ‘a’ and the additional data ‘d’. Also, unlike the related art apparatus which should use four (4) section filters in order to monitor whether the additional data ‘a’, the additional data ‘b’, the additional data ‘c’, and the additional data ‘d’ are updated, the apparatus 400 of FIG. 5 can monitor whether the additional data ‘a’, ‘b’, ‘c’, and ‘d’ are updated by using just one (1) section filter by monitoring whether the update information list is updated, thereby improving efficiency in using system resources.

FIG. 6 is a flowchart illustrating a method of transmitting additional data according to an exemplary embodiment of the present invention.

In operation S610, an update information list including information regarding updates of additional data is generated. The additional data and the update information list may be section data transported in MPEG-2 streams.

The update information list generated in operation S610 may include at least one of identifiers for identifying the additional data, version information of the additional data, update time information of the additional data, and data types of the additional data.

In operation S620, the generated update information list is transmitted along with the additional data.

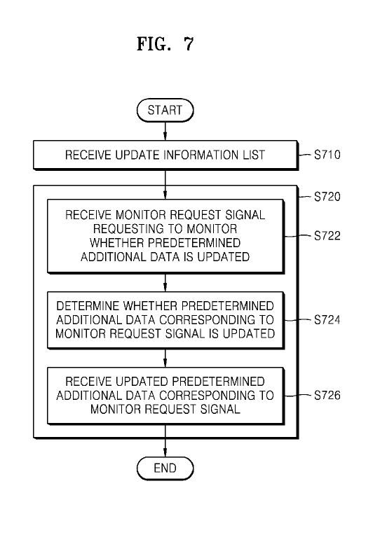

FIG. 7 is a flowchart illustrating a method of receiving additional data according to an exemplary embodiment of the present invention.

In operation S710, an update information list including information regarding updates of the additional data is received. The additional data and the update information list may be section data transported in MPEG-2 streams. Also, the generated update information list may include at least one of identifiers for identifying the additional data, version information of the additional data, update time information, and data types of the additional data.

In operation S720, at least one piece of updated additional data is received on the basis of the received update information list.

Operation S720 may further include determining whether the received update information list is updated. If it is determined that the update information list is updated, the received update information list is parsed, and at least one piece of the updated additional data is received on the basis of the parsed update information list. However, if it is determined that the update information is not updated, it is determined that there is no updated additional data, and the received update information list is skipped instead of being parsed.

Operation S720 may include operations S722 through S726.

In operation S722, a monitor request signal requesting to monitor whether predetermined additional data is updated is received.

In operation S724, it is determined whether the predetermined additional data corresponding to the monitor request signal is updated on the basis of the update information list.

In operation S726, the updated predetermined additional data corresponding to the monitor request signal is received on the basis of the determination result in operation S724. If it is determined in operation S724 that the plurality of additional data corresponding to the monitor request signal is updated, the plurality of additional data is sequentially received in an order in which the additional data is updated on the basis of the update information list.

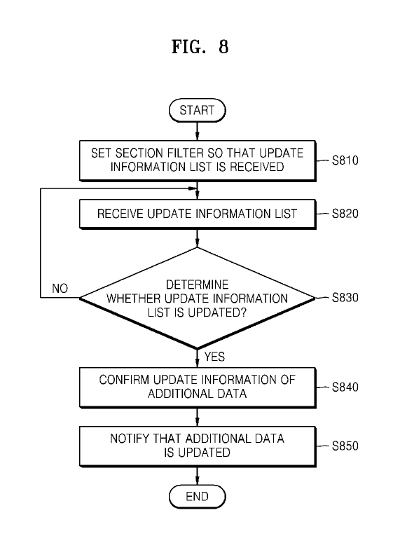

FIG. 8 is a flowchart illustrating a method of receiving additional data according to another exemplary embodiment of the present invention. In FIG. 8, the additional data and an update information list are section data transported in MPEG-2 streams.

In operation S810, a section filter is set so that the update information list is selectively received.

In operation S820, the update information list is received by the section filter set in operation S810.

In operation S830, it is determined whether the received update information list is updated.

If it is determined that the received update information list is not updated, it is determined that there is no updated additional data and the method returns to operation S820.

If it is determined that the received update information list is updated, the method proceeds to operation S840.

In operation S840, the received update information list is parsed and update information of the additional data is confirmed.

In operation S850, a module requesting to monitor the updated additional data, is notified that the corresponding additional data is updated.

Embodiments of the present invention may be embodied as computer executable programs, or may be embodied in a general purpose digital computer by running a program from a computer-readable medium.

Examples of the computer-readable medium include storage media such as magnetic storage media (e.g., read only memories (ROMs), floppy discs, or hard discs), optically readable media (e.g., compact disk-read only memories (CD-ROMs), or digital versatile disks (DVDs)) and carrier waves (e.g., transmissions over the Internet).

As described above, since section data including update information of additional data is generated and transmitted and only the section data including the update information is monitored by a receiver without monitoring all additional data, the additional data can be efficiently updated. Accordingly, the present invention can efficiently use limited hardware resources.

Furthermore, since the section data including the update information of the additional data is generated and transmitted, an order in which the additional data is updated can be guaranteed by the receiver.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of receiving updated additional data from among additional data related to a broadcasting service, the method comprising:
receiving an update information list comprising information regarding updates of the additional data; and
receiving at least one piece of updated additional data based on the received update information list.

2. The method of claim 1, wherein the additional data and the update information list are section data transported in Moving Picture Experts Group (MPEG)-2 streams.

3. The method of claim 1, wherein the receiving the at least one piece of the updated additional data comprises:
receiving a monitor request signal which requests to monitor whether predetermined additional data is updated;
determining whether the predetermined additional data corresponding to the monitor request signal is updated based on the update information list; and
receiving the predetermined additional data corresponding to the monitor request signal based on a result of the determining.

4. The method of claim 3, wherein the receiving the additional data comprises:
if it is determined that a plurality of additional data corresponding to the monitor request signal is updated, sequentially receiving the plurality of additional data in an order in which the plurality of additional data is updated based on the update information list.

5. The method of claim 1, wherein the receiving the at least one piece of the updated additional data comprises:
determining whether the received update information list is updated; and
receiving at least one piece of updated additional data based on the update information list if it is determined that the update information list is updated.

6. The method of claim 1, wherein the information of the update information list comprises at least one of identifiers for identifying the additional data, version information of the additional data, update time information of the additional data, and data types of the additional data.

7. A method of transmitting additional data related to a broadcasting service, the method comprising:
generating an update information list comprising information regarding updates of the additional data; and
transmitting the generated update information list along with the additional data.

8. The method of claim 7, wherein the additional data and the update information list are section data transported in Moving Picture Experts Group (MPEG)-2 streams.

9. The method of claim 7, wherein the information of the update information list comprises at east one of identifiers for identifying the additional data, version information of the additional data, update time information of the additional data, and data types of the additional data.

10. An apparatus for receiving updated additional data from among additional data related to broadcasting service, the apparatus comprising:
an update information list receiving unit which receives an update information list comprising information regarding updates of the additional data; and
a receiving unit which receives at least one piece of updated additional data based on the received update information list.

11. The apparatus of claim 10, wherein the additional data and the update information list are section data transported in Moving Picture Experts Group (MPEG)-2 streams.

12. The apparatus of claim 10, wherein the receiving unit comprises:
a monitor request signal receiving unit which receives a monitor request signal which requests to monitor whether predetermined additional data is updated;
a determining unit which determines whether the predetermined additional data corresponding to the monitor request signal is updated based on the update information list; and
an additional data receiving unit which receives the updated predetermined additional data corresponding to the monitor request signal based on a result of the determination by the determining unit.

13. The apparatus of claim 12, wherein, if the determining unit determines that a plurality of additional data corresponding to the monitor request signal is updated, the additional data receiving unit sequentially receives the plurality of additional data in an order in which the plurality of additional data is updated based on the update information list.

14. The apparatus of claim 10, wherein the receiving unit comprises:
a determining unit which determines whether the received update information list is updated; and
an additional data receiving unit which receives at least one piece of updated additional data based on the update information list if the determining unit determines that the update information list is updated.

15. The apparatus of claim 10, wherein the information of the update information list comprises at least one of identifiers for identifying the additional data, version information of the additional data, update time information of the additional data, and data types of the additional data.

16. An apparatus of transmitting additional data related to a broadcasting service, the apparatus comprising:
an update information list generating unit which generates an update information list comprising information regarding updates of the additional data; and
a transmitting unit which transmits the generated update information list along with the additional data.

17. The apparatus of claim 16, wherein the additional data and the update information list are section data transported in Moving Picture Experts Group (MPEG)-2 streams.

18. The apparatus of claim 16, wherein information of the update information list comprises at least one of identifiers for identifying the additional data, version information of the additional data, update time information of the additional data, and data types of the additional data.

19. A computer-readable recording medium having recorded thereon a program for executing the method of claim 1.

20. A computer-readable recording medium having recorded thereon a program for executing the method of claim 7.
